(19) United States
(12) Patent Application Publication
(10) Pub. No.: US 2014/0184951 A1
(43) Pub. Date: Jul. 3, 2014

(54) TOUCH DISPLAY DEVICE

(71) Applicant: WINTEK CORPORATION, Taichung City (TW)

(72) Inventors: Cheng-Yen Yeh, Taichung City (TW); Yu-Ting Chen, Taoyuan County (TW); Chen-Hao Su, Taichung City (TW); Kuo-Chang Su, Taichung City (TW)

(73) Assignee: WINTEK CORPORATION, Taichung City (TW)

(21) Appl. No.: 14/141,383

(22) Filed: Dec. 26, 2013

(30) Foreign Application Priority Data
Dec. 27, 2012 (TW) 101150463

(51) Int. Cl. G06F 3/041

(52) U.S. Cl. CPC G06F 3/041
USPC 349/12

(57) ABSTRACT

A touch display device includes a cover substrate, a display panel, a plurality of first touch electrodes, a plurality of first connecting pads, and a first conductive adhesive material. A visible region and a peripheral region adjacent to at least one side of the visible region are defined on the cover substrate. The display panel includes an upper substrate and an array substrate. The upper substrate is disposed between the cover substrate and the array substrate. The first touch electrodes are disposed in the visible region and the first connecting pads are disposed in the peripheral region. Each first connecting pad is electrically connected to the corresponding first touch electrode. The first conductive adhesive material is disposed between the cover substrate and the array substrate so as to electrically connect the first connecting pads and the array substrate.

### BACKGROUND OF THE INVENTION

1. Field of the Invention

The present invention relates to a touch display device, and more particularly, to a touch display device including touch electrodes electrically connected to an array substrate by a conductive adhesive material.

2. Description of the Prior Art

Nowadays, mobile phones, GPS navigator system, personal digital, tablet PCs, assistants (PDA) and notebook PCs with touch functions are wildly used in modern life. In the above-mentioned electronic products, the touch display devices can be obtained by integrating the original display function with the touch sensing function. An out-cell touch display panel, which includes a display panel and a touch panel adhered to each other, is one of the mainstream development in the field of the touch display devices. Generally, the touch panels can be mainly divided into two types according to their structure, i.e. the glass/glass touch panels and the one glass solution (OGS) touch panels. In the glass/glass touch panel, since a touch sensing unit is formed on the cover glass directly, the total amount of glass substrate used in the OGS touch panel is reduced. Accordingly, the OGS touch panel can presents small form with simplified structure.

The amount of connecting pads in outer devices such as a flexible printed circuit (FPC) has to be increased while touch resolution of a touch panel increases and/or single-layered sensing electrodes are applied. The connecting pads on the FPC have to be disposed more closely to one another within a limited size of the FPC. Alignments during bonding processes between touch panels and outer devices such as a FPC may be a problem, and the production yield may be affected accordingly. In addition, the alignment issue mentioned above may also occur when the connecting pads and/or alignment marks are transparent and hard to be distinguished.

### SUMMARY OF THE INVENTION

It is one of the objectives of the present invention to provide a touch display device. A conductive adhesive material is used to electrically connect touch electrodes and an array substrate in a display panel. A touch driving unit is electrically connected to the touch electrodes via the array substrate, and purposes of yield enhancement and process simplification may be achieved accordingly.

To achieve the purposes described above, a preferred embodiment of the present invention provides a touch display device. The touch display device includes a cover substrate, a display panel, a plurality of first touch electrode, a plurality of first connecting pads, and a first conductive adhesive material. A visible region and a peripheral region adjacent to at least one side of the visible region are defined on the cover substrate. The display panel is disposed opposite to the cover substrate. The display panel includes an upper substrate, an array substrate, and a display medium. The array substrate is disposed opposite to the upper substrate, and the upper substrate is disposed between the cover substrate and the array substrate. The display medium is disposed between the upper substrate and the array substrate. The first touch electrodes are at least disposed in the visible region of the cover substrate. The first connecting pads are disposed in the peripheral region, and each of the first connecting pads is electrically connected to one of the first touch electrodes. The first conductive adhesive material is disposed between the cover substrate and the array substrate so as to electrically connect the first connecting pads and the array substrate.

To achieve the purposes described above, another preferred embodiment of the present invention provides a touch display device. The touch display device includes a cover substrate, a display panel, a plurality of first touch electrodes, a plurality of second touch electrodes and a conductive adhesive material. A visible region and a peripheral region adjacent to at least one side of the visible region are defined on the cover substrate. The display panel is disposed opposite to the cover substrate. The display panel includes an upper substrate, an array substrate and a display medium. The array substrate is disposed opposite to the upper substrate, and the upper substrate is disposed between the cover substrate and the array substrate. The display medium is disposed between the upper substrate and the array substrate. The first touch electrodes are at least disposed in the visible region of the cover substrate. The second touch electrodes are disposed on the upper substrate of the display panel. The conductive adhesive material is disposed between the cover substrate and the upper substrate so as to electrically connect the second touch electrodes and the cover substrate.

To achieve the purposes described above, another preferred embodiment of the present invention provides a touch display device. The touch display device includes a cover substrate, a display panel, a plurality of first touch electrodes, a plurality of second touch electrodes and a conductive adhesive material. A visible region and a peripheral region adjacent to at least one side of the visible region are defined on the cover substrate. The display panel is disposed opposite to the cover substrate. The display panel includes an upper substrate, an array substrate and a display medium. The array substrate is disposed opposite to the upper substrate. The upper substrate is disposed between the cover substrate and the array substrate. The display medium is disposed between the upper substrate and the array substrate. The first touch electrodes are at least disposed in the visible region of the cover substrate. The second touch electrodes are disposed on the upper substrate of the display panel. The conductive adhesive material is disposed between the cover substrate and the upper substrate so as to electrically connect the first touch electrodes and the upper substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a touch display device according to a first preferred embodiment of the present invention.

FIG. 2 is a partially enlarged diagram of FIG. 1.

FIG. 3 is a top view diagram illustrating a cover substrate of the touch display device according to the first preferred embodiment of the present invention.

FIG. 4 is a top view diagram illustrating an array substrate of the touch display device according to the first preferred embodiment of the present invention.

FIG. 5 is a top view diagram illustrating an array substrate of a touch display device according to another preferred embodiment of the present invention.

FIG. 6 is a top view diagram illustrating touch electrodes of a touch display device according to another preferred embodiment of the present invention.

FIG. 7 is a top view diagram illustrating touch electrodes of a touch display device according to further another preferred embodiment of the present invention.

FIG. 8 is a schematic diagram illustrating a touch display device according to a second preferred embodiment of the present invention.

FIG. 9 is a top view diagram illustrating touch electrodes of the touch display device according to the second preferred embodiment of the present invention.

FIG. 10 is a top view diagram illustrating a cover substrate of the touch display device according to the second preferred embodiment of the present invention.

FIG. 11 is a top view diagram illustrating an array substrate of the touch display device according to the second preferred embodiment of the present invention.

FIG. 12 is a top view diagram illustrating an upper substrate of the touch display device according to the second preferred embodiment of the present invention.

FIG. 13 is a schematic diagram illustrating a touch display device according to a third preferred embodiment of the present invention.

FIG. 14 is a top view diagram illustrating a cover substrate of the touch display device according to the third preferred embodiment of the present invention.

FIG. 15 is a top view diagram illustrating an array substrate of the touch display device according to the third preferred embodiment of the present invention.

FIG. 16 is a schematic diagram illustrating a touch display device according to a fourth preferred embodiment of the present invention.

FIG. 17 is a top view diagram illustrating a cover substrate of the touch display device according to the fourth preferred embodiment of the present invention.

FIG. 18 is a top view diagram illustrating an upper substrate of the touch display device according to the fourth preferred embodiment of the present invention.

FIG. 19 is a schematic diagram illustrating a touch display device according to a fifth preferred embodiment of the present invention.

FIG. 20 is a schematic diagram illustrating a touch display device according to a sixth preferred embodiment of the present invention.

FIG. 21 is a schematic diagram illustrating a touch display device according to a seventh preferred embodiment of the present invention.

FIG. 22 is a top view diagram illustrating the touch display device according to the seventh preferred embodiment of the present invention.

FIG. 23 is a partially enlarged diagram of FIG. 22.

FIG. 24 is an enlarged schematic diagram illustrating a connecting region between the touch display device and a flexible printed circuit according to the seventh preferred embodiment of the present invention.

### DETAILED DESCRIPTION

To provide a better understanding to skilled users in the technology, the embodiments will be detailed as follows. The embodiments are illustrated in the accompanying drawings with numbered elements to elaborate the contents and effects to be achieved.

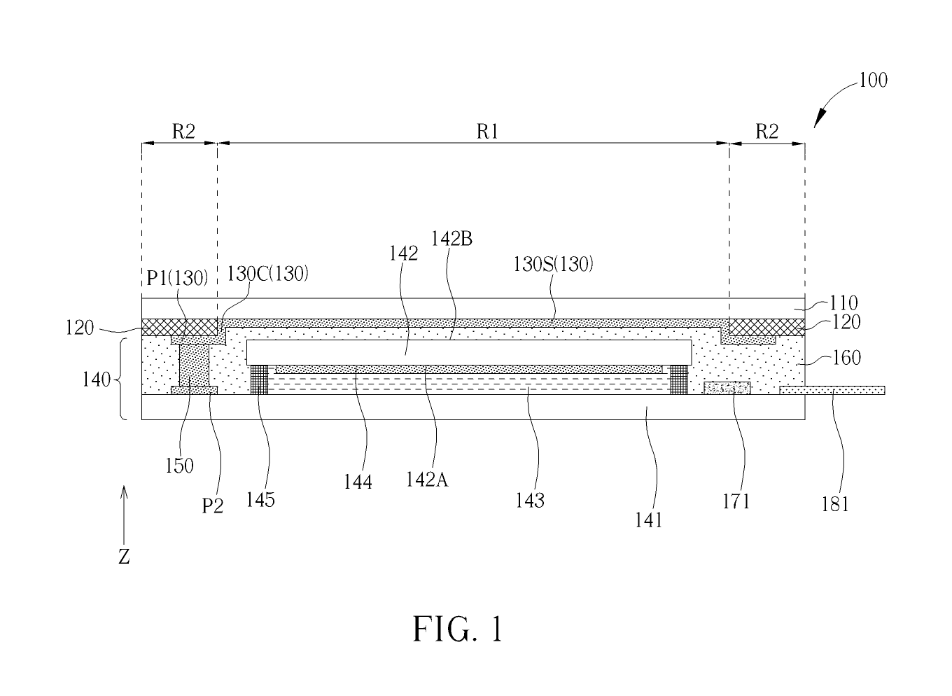

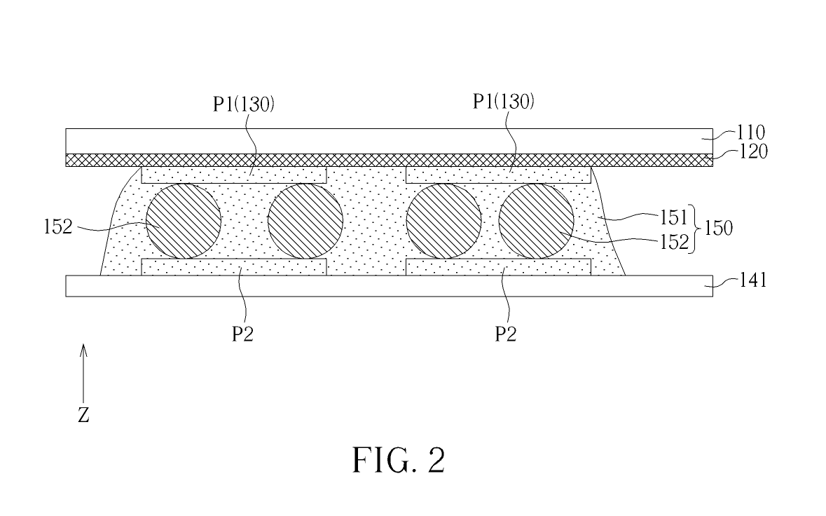

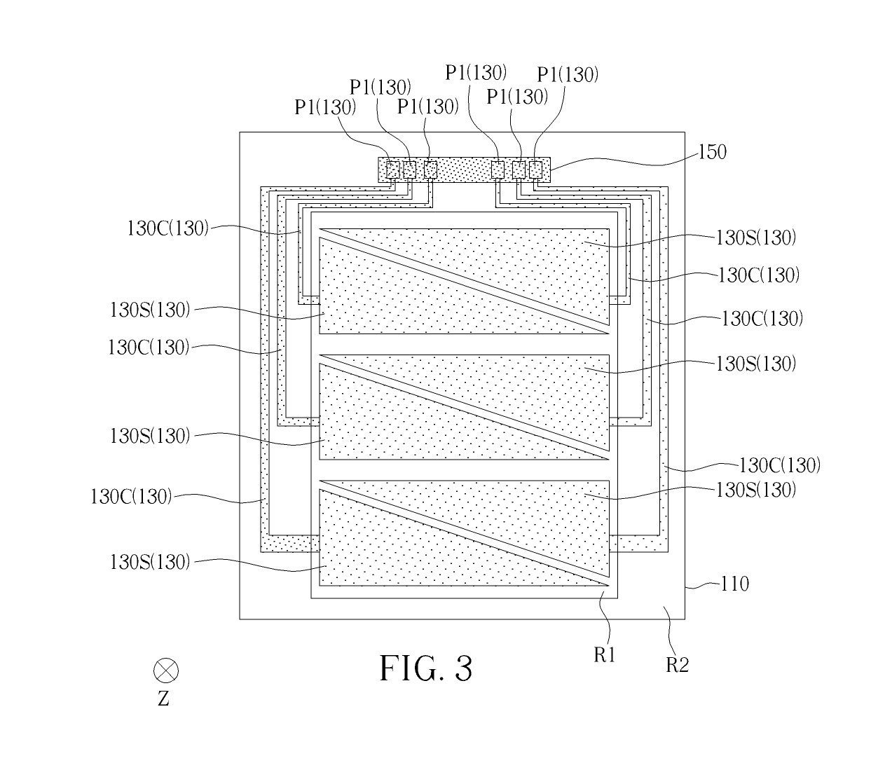

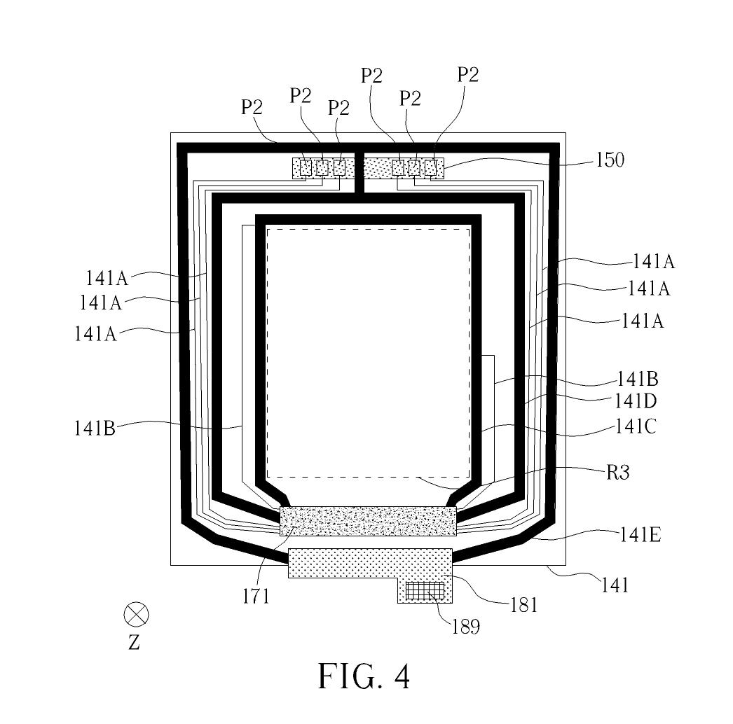

Please refer to FIGS. 1-4. FIG. 1 is a schematic diagram illustrating a touch display device according to a first preferred embodiment of the present invention. FIG. 2 is a partially enlarged diagram of FIG. 1. FIG. 3 is a top view diagram illustrating a cover substrate of the touch display device in this embodiment. FIG. 4 is a top view diagram illustrating an array substrate of the touch display device in this embodiment. Please note that the figures are only for illustration and the figures may not be to scale. The scale may be further modified according to different design considerations. As shown in FIGS. 1-3, a touch display device 100 is provided in this embodiment. The touch display device 100 includes a cover substrate 110, a display panel 140, a plurality of first touch electrode 130S, a plurality of first connecting pads P1, and a first conductive adhesive material 150. In this embodiment, the cover substrate 110 may preferably include a rigid cover substrate, such as a cover glass, a flexible cover substrate, such as a thin glass and a plastic cover substrate, or other cover substrates made of suitable materials. A visible region R1 and a peripheral region R2 adjacent to at least one side of the visible region R1 are defined on the cover substrate 110. In this embodiment, the peripheral region R2 surrounds the visible region R1, but not limited thereto. The display panel 140 is disposed opposite to the cover substrate 110. The display panel 140 includes an upper substrate 142, an array substrate 141, and a display medium 143. The upper substrate 142 is disposed opposite to the array substrate 141, and the upper substrate 142 is disposed between the cover substrate 110 and the array substrate 141. The display medium 143 is disposed between the upper substrate 142 and the array substrate 141. The display medium 143 in this embodiment may preferably include liquid display material, an organic light emitting display material, an electro-wetting display material, an e-ink display material, a plasma display material, a field emission display (FED) material, or other appropriate display materials. Accordingly, the display panel 140 may preferably include a liquid display panel, an organic light emitting diode (OLED) display panel, an electro-wetting display panel, an e-ink display panel, a plasma display panel or a FED panel, but not limited thereto. In this embodiment, the display panel 140 is regarded as a liquid crystal display panel for illustrating the present invention, but not limited thereto. The upper substrate 142 may include a color filter substrate. The upper substrate 142 has an inner surface 142A and an outer surface 142B opposite to the inner surface 142A. The inner surface 142A faces the array substrate 141. A common electrode 144 may be selectively disposed on the inner surface 142A of the upper substrate 142, but not limited thereto. The upper substrate 142 and the array substrate 141 may be combined via a sealant 145. The first touch electrodes 130S are at least disposed in the visible region R1 of the cover substrate 110. The first connecting pads P1 are disposed in the peripheral region R2, and each of the first connecting pads P1 is electrically connected to one of the first touch electrodes 130S. Each of the first touch electrodes 130S corresponds to one of the first connecting pads P1. The first conductive adhesive material 150 is disposed between the cover substrate 110 and the array substrate 141 so as to electrically connect the first connecting pads P1 and the array substrate 141.

Additionally, the touch display device 100 may further include a decoration layer 120 and a plurality of first conductive lines 130C. The decoration layer 120 is disposed in the peripheral region R2 of the cover substrate 110. The decoration layer 120 may be configured to define the visible region R1 and the peripheral region R2 on the cover substrate 110, but not limited thereto. Each of the first conductive lines 130C is electrically connected to one of the first touch electrodes 130S and one of the first connecting pads P1. In this embodiment, the first touch electrodes 130S, the first connecting pads P1, and the first conductive lines 130C may preferably be one patterned conductive layer 130 disposed on the cover substrate 110. In other words, each first conductive line 130C, the corresponding first touch electrode 130S, and the corresponding first connecting pad P1 are preferably connected to one another and formed monolithically, but not limited thereto. The first touch electrode 130S are preferably formed by performing a patterning process to one conductive material layer, and the first conductive lines 130C, the first connecting pads P1, and the first touch electrodes 130 are formed after the patterning process. Therefore, each first conductive line 130C, the corresponding first touch electrodes 130S, and the corresponding first connecting pads P1 are connected to one another when the first conductive lines 130C, the first connecting pads P1, and the first touch electrodes 130 are formed on the cover substrate 110. The patterned conductive layer 130 in this embodiment may include indium tin oxide (ITO), indium zinc oxide (IZO), aluminum zinc oxide (AZO), indium gallium zinc oxide (IGZO), nano-silver yarns, or other appropriate transparent conductive materials. Additionally, the patterned conductive layer 130 may also be a patterned thin metal layer, such as silver, a metal mesh composed of metal thin lines, or other non transparent materials which are not visible by human eyes. However, the first conductive lines 130C, the first connecting pads P1, and the first touch electrodes 130 may also be formed separately and be formed by different materials. In addition, the first touch electrodes 130S may also extend to the peripheral region R2 so as to be electrically connected to the first connecting pads P1 directly, and the first touch electrodes 130S may be directly connected to the first connecting pads P1 without the first conductive lines 130C. Otherwise, an end of the first touch electrode 130S extending to the peripheral region R2 may form the first connecting pad P1 directly. In this embodiment, a pitch between two adjacent first connecting pads P1 is defined as a distance between two center points of the two adjacent first connecting pads P1, and the pitch between two adjacent first connecting pads P1 is preferably smaller than or equal to 0.25 millimeter, but not limited thereto. Additionally, the cover substrate 110 and the display panel 140 may be combined by a adhesive layer 160, but not limited thereto.

As shown in FIGS. 1-4, the array substrate 141 may include a plurality of second connecting pads P2 disposed correspondingly to the first connecting pads P1 on the cover substrate 110 along a vertical projective direction Z. The first conductive adhesive material 150 may preferably be a conductive adhesive material made by mixing an adhesive material 151 and a plurality of conductive particles 152, but the present invention is not limited to this. In other preferred embodiments of the present invention, other appropriate conductive adhesive materials, such as conductive rubber, may also be used to electrically connect the first connecting pads P1 and the second connecting pads P2 according to other design considerations. It is worth noting that, as shown in FIG. 2, the first conductive adhesive material 150 may preferably contact the first connecting pads P1 and the second connecting pads P2 by a full conduction approach. The conductive particles 152 distributed over the adhesive material 151 is used to contact the first connecting pads P1 and the second connecting pads P2 along the vertical projective direction Z so as to electrically connect each first connecting pad P1 and the corresponding second connecting pad P2. The density of the conductive particles 152 in the adhesive material 151 may be carefully controlled so as to electrically isolate the first connecting pads P1 from one another, and to electrically isolate the second connecting pads P2 from one another. Additionally, as shown in FIG. 3 and FIG. 4, the first conductive adhesive material 150 is a pattern coated on the cover substrate 110 and/or the array substrate 141, and the first connecting pads P1 may be electrically connected to the second connecting pads P2 without performing precise alignment steps. The purpose of process simplification may be achieved accordingly.

As shown in FIG. 1 and FIG. 4, the touch display device 100 in this embodiment may further include a touch driving unit 171 and a flexible printed circuit 181. The touch driving unit 171 and the flexible printed circuit 181 are disposed on the array substrate 141. The touch driving unit 171 may include an integrated circuit (IC), but not limited thereto. The array substrate 141 may further include a plurality of touch signal lines 141A, a plurality of display signal lines 141B, an inner common voltage line 141C, an outer common voltage line 141D, and a shielding ground wire 141E. An end of each touch signal line 141A is electrically connected to one of the second connecting pads P2, and the other end of each touch signal line 141A is electrically connected to the touch driving unit 171. Accordingly, the array substrate 141 is electrically connected to each first connecting pad P1 and the corresponding first touch electrode 130S via the first conductive adhesive material 150. An outer device, such as the touch driving unit 171, which is used to control the first touch electrodes 1305, may be formed directly on the array substrate 141 and electrically connected to the first touch electrodes 130S via the array substrate 141. The difficulty of the bonding process between the array substrate 141 and the flexible printed circuit 181 will not be influenced when the amount of the touch signal lines 141A increases as the amount of the first touch electrodes 130S increases because a more precise bonding process is an essential process between general array substrates and flexible printed circuits. It is worth noting that, in the array substrate 141 of this embodiment, an end of the display signal line 141B is connected to a device such as a thin film transistor (TFT, not shown) disposed in a display region R3 of the array substrate 141, and the other end of the display signal line 141B is electrically connected to the touch driving unit 171. Additionally, the inner common voltage line 141C, the outer common voltage line 141D, and the shielding ground wire 141E may also be electrically connected to the touch driving unit 171 or/and the flexible printed circuit 181. In other words, the touch driving unit 171 and the flexible printed circuit 181 in this embodiment may be used to control both the touch signals and the display signals, and the purposes of device simplification and material cost reduction may be achieved accordingly. In addition, the flexible printed circuit 181 may include a connector 189, and the connector 189 may also be used to transmit both the touch signals and the display signals, but not limited thereto.

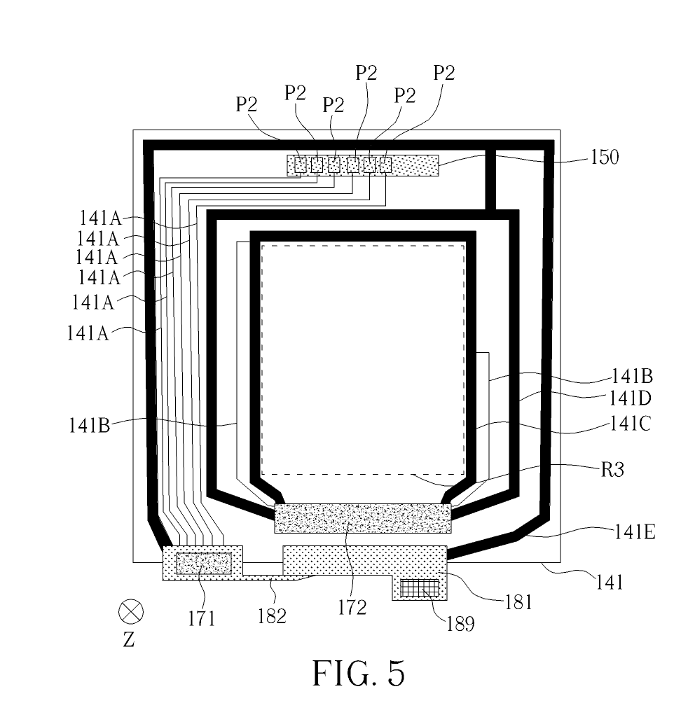

Please refer to FIG. 4 and FIG. 5. FIG. 5 is a top view diagram illustrating an array substrate of a touch display device according to another preferred embodiment of the present invention. As shown in FIG. 5, in another preferred embodiment, a flexible printed circuit 182 is disposed on the array substrate 141 and electrically connected to the array substrate 141, and the touch driving unit 171 is disposed on the flexible printed circuit 182. The difference between this embodiment and the first preferred embodiment described above is that a display driving unit 172 may be disposed on the array substrate 141 of this embodiment, and the display driving unit 172 is electrically connected to the display signal line 141B. In other words, the touch signals and the display signals in this embodiment only share the connector 189 on the flexible printed circuit 182. The touch driving unit 171 and the display driving unit 172 are employed for the touch signals and the display signals respectively.

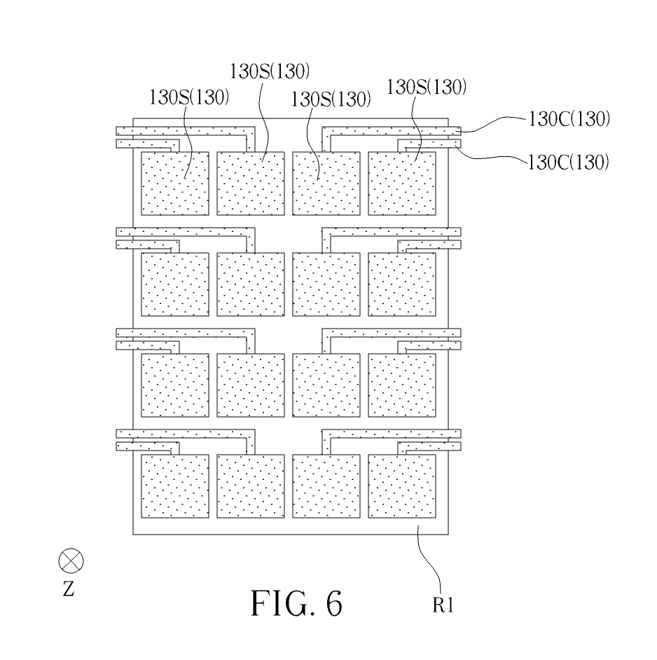

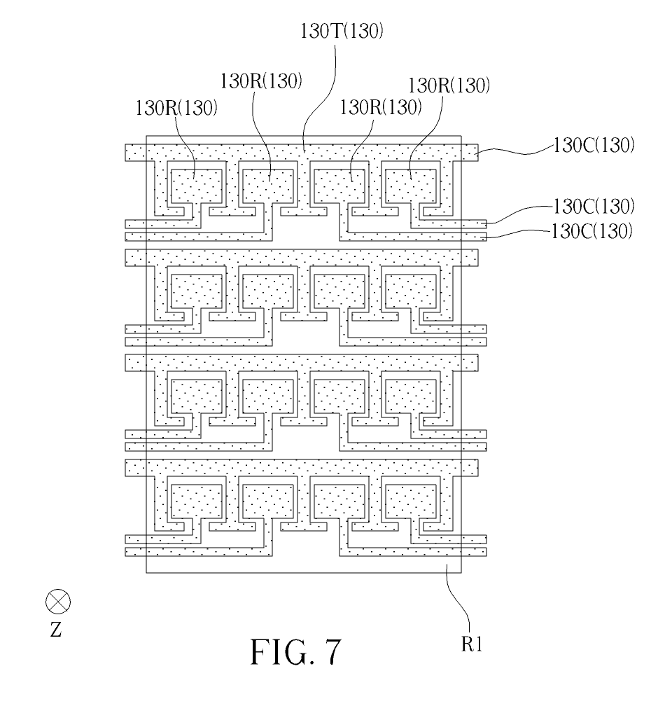

Please refer to FIG. 3, FIG. 6 and FIG. 7. FIG. 6 is a top view diagram illustrating touch electrodes of a touch display device according to another preferred embodiment of the present invention. FIG. 7 is a top view diagram illustrating touch electrodes of a touch display device according to further another preferred embodiment of the present invention. As shown in FIG. 3, each of the touch electrodes 130S in the first preferred embodiment is a triangle electrode, but the present invention is not limited to this. In other preferred embodiments of the present invention, electrodes in other appropriate shapes may also be employed as the first touch electrodes 130S according to other considerations. For example, the first touch electrode 130S may be a rectangular electrode as shown in FIG. 6. Additionally, as shown in FIG. 7, the first touch electrodes 130S may also include a plurality of signal transmitting electrodes 130T and a plurality of signal receiving electrodes 130R. The signal transmitting electrodes 130T are used to transmit touch sensing signals, and the signal receiving electrodes 130R are used to receive the touch sensing signals in a mutual capacitive touch sensing operation mode, but not limited thereto. In other embodiments of the present invention without diagram illustrations, the touch electrodes may have a bridge structure apart from the single layer structure described above. In the bridge structure, a metal or non-metal bridge line and an insulating layer are used to electrically connect electrodes in identical axes and to electrically isolate electrodes in different axes.

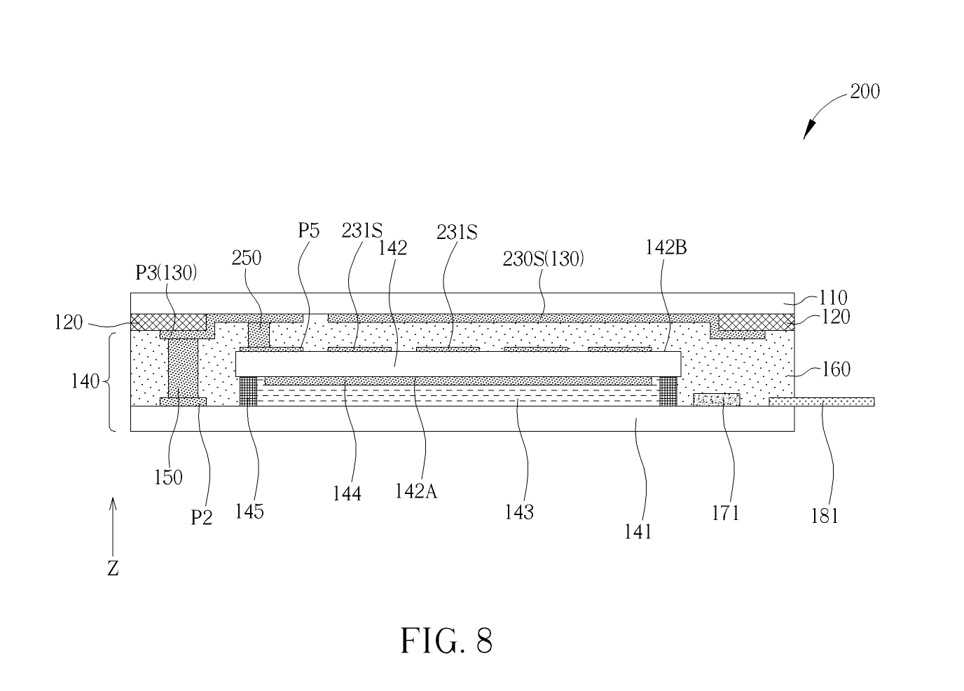

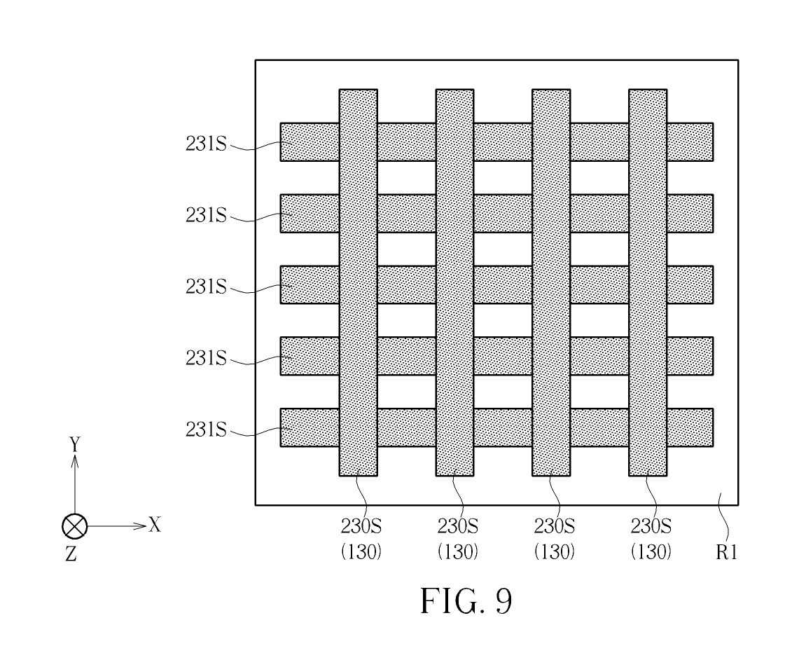

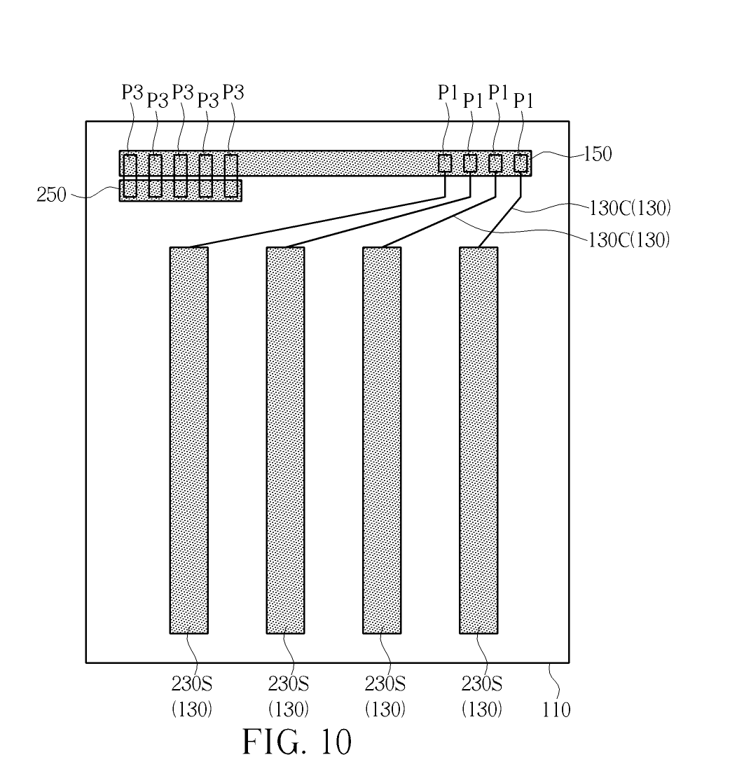

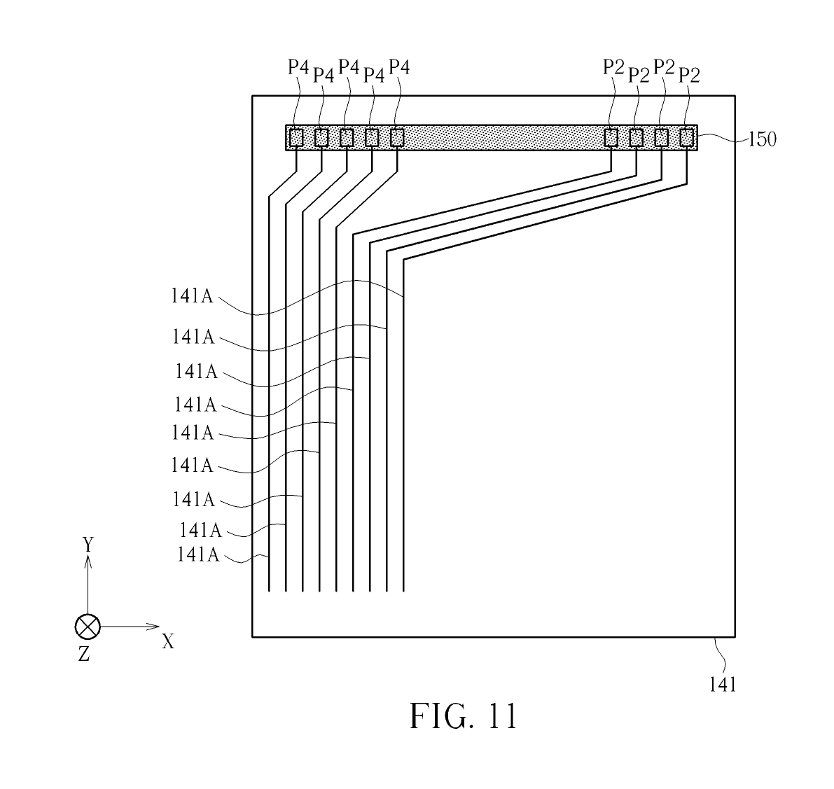

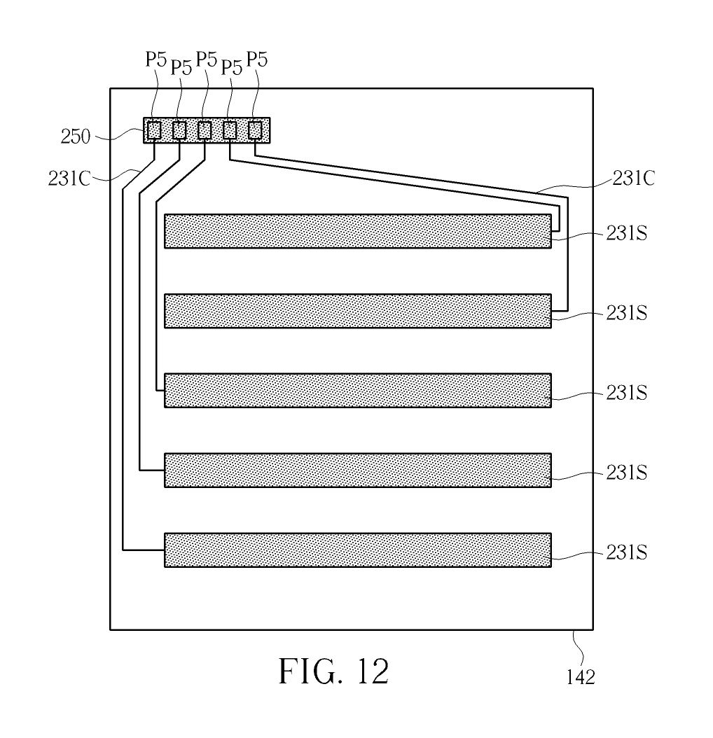

Please refer to FIGS. 8-12. FIG. 8 is a schematic diagram illustrating a touch display device according to a second preferred embodiment of the present invention. FIG. 9 is a top view diagram illustrating touch electrodes of the touch display device in this embodiment. FIG. 10 is a top view diagram illustrating a cover substrate of the touch display device in this embodiment. FIG. 11 is a top view diagram illustrating an array substrate of the touch display device in this embodiment. FIG. 12 is a top view diagram illustrating an upper substrate of the touch display device in this embodiment. As shown in FIGS. 8-12, the difference between a touch display device 200 in this embodiment and the touch display device in the first preferred embodiment described above is that the touch display device 200 further includes a plurality of second touch electrodes 231S, a second conductive adhesive material 250, a plurality of first touch electrodes 230S and a plurality of third connecting pads P3. The array substrate 141 further includes plurality of fourth connecting pads P4. The second touch electrodes 231S are disposed on the outer surface 142B of the upper substrate 142, and the outer surface 142B of the upper substrate 142 faces the cover substrate 110. The first touch electrodes 230S are preferably stripe electrodes extending along a second direction Y, the second touch electrodes 231S are preferably stripe electrodes extending along a first direction X, and the first direction X is preferably perpendicular to the second direction Y, but not limited thereto. In other words, the first touch electrode 230S and the second touch electrode 231S partially overlap each other along the vertical projective direction Z. The first touch electrode 230S and the second touch electrode 231S may be a touch signal transmitting electrode and a touch signal receiving electrode respectively so as to perform the mutual capacitive touch sensing operation mode, but not limited thereto.

The second conductive adhesive material 250 is disposed between the cover substrate 110 and the upper substrate 142, the third connecting pads P3 are disposed on the cover substrate 110, and the second conductive adhesive material 250 electrically connects the second touch electrodes 231S and the third connecting pads P3. Specifically, the touch display device 200 may further include a plurality of fifth connecting pads P5 and a plurality of second conductive lines 231C disposed on the upper substrate 142. The fifth connecting pads P5 are disposed correspondingly to at least some of the third connecting pads P3. Each of the fifth connecting pads P5 is electrically connected to one of the second touch electrodes 231S via the second conductive line 231C. The second touch electrodes 231S may be electrically connected to the third connecting pads P3 via the second conductive lines 231C, the fifth connecting pads P5 and the second conductive adhesive material 250. In addition, the fourth connecting pads P4 are disposed correspondingly to the third connecting pads P3, the fourth connecting pads P4 are connected with the touch signal lines 141A, and each of the fourth connecting pads P4 is electrically connected to one of the third connecting pads P3 via the first conductive adhesive material 150. In other words, the touch electrodes 231S disposed on the outer surface 142B of the upper substrate 142 maybe electrically connected to the touch signal lines 141A orderly via the second conductive line 231C, the fifth connecting pad P5, the second conductive adhesive material 250, the third connecting pad P3, the first conductive adhesive material 150 and the fourth connecting pad P4. It is worth noting that, as shown in FIG. 8, FIG. 10 and FIG. 12, the second conductive adhesive material 250 may preferably contact the third connecting pads P3 and the fifth connecting pads P5 by a full conduction approach. The material properties and the electrical connecting mechanism of the second conductive adhesive material 250 are similar to those of the first conductive adhesive material 150 described above and will not be redundantly described. As shown in FIG. 8, FIG. 10 and FIG. 12, the second conductive adhesive material 250 may be a pattern coated on the cover substrate 110 and/or the upper substrate 142, and the fifth connecting pads P5 may be electrically connected to the third connecting pads P3 without performing precise alignment steps. In addition, each first conductive line 130C, the corresponding first touch electrode 230S, and the corresponding first connecting pad P1 are preferably connected to one another and formed monolithically, but not limited thereto. Each first conductive line 130C, the corresponding first touch electrode 230S, and the corresponding first connecting pad P1 may also be formed separately. The third connecting pads P3 are separated from the first conductive lines 130C, the first touch electrodes 230S and the first connecting pads P1 so as to avoid signal interference. Each second conductive line 231C, the corresponding second touch electrode 231S, and the corresponding fifth connecting pad P5 are preferably connected to one another and formed monolithically, but not limited thereto. Each second conductive line 231C, the corresponding second touch electrode 231S, and the corresponding fifth connecting pad P5 may also be formed separately.

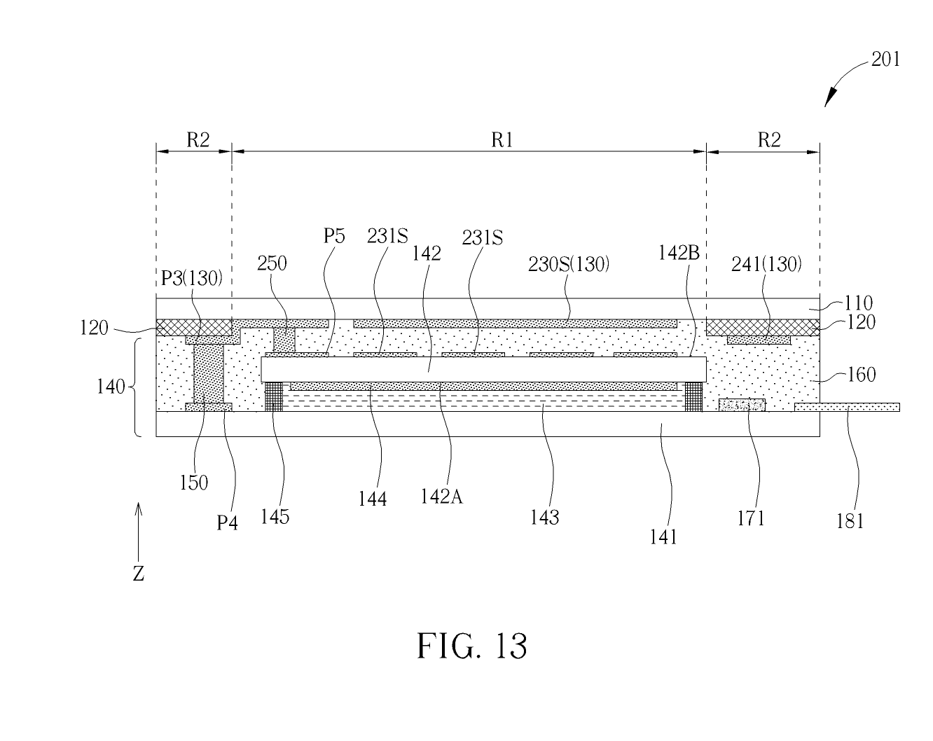

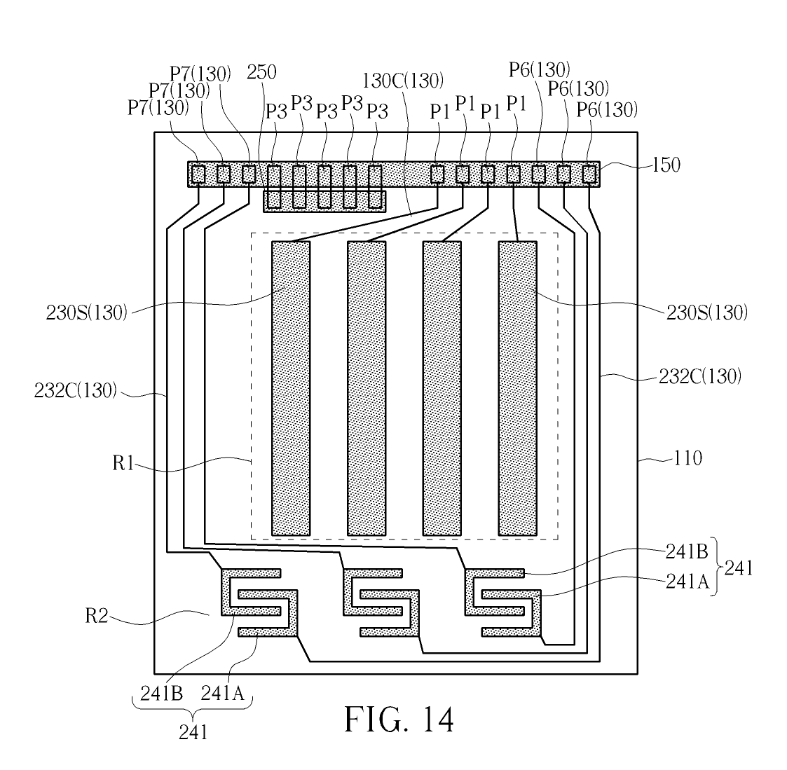

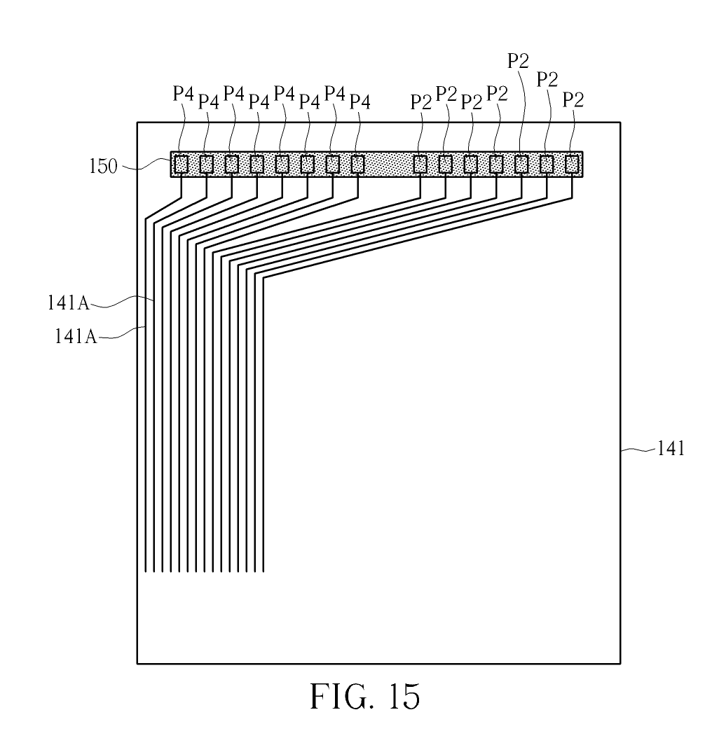

Please refer to FIGS. 13-15. FIG. 13 is a schematic diagram illustrating a touch display device according to a third preferred embodiment of the present invention. FIG. 14 is a top view diagram illustrating a cover substrate of the touch display device in this embodiment. FIG. 15 is a top view diagram illustrating an array substrate of the touch display device in this embodiment. As shown in FIGS. 13-15, the difference between a touch display device 201 in this embodiment and the touch display device in the second preferred embodiment described above is that the touch display device 201 further includes at least one first peripheral touch electrode 241. The first peripheral touch electrode 241 is disposed on the cover substrate 110 and disposed in the peripheral region R2 so as to correspond to a button pattern (not shown) disposed on the cover substrate 110 in the peripheral region R2. The first peripheral touch electrode 241 is electrically connected to the array substrate 141 via the first conductive adhesive material 150. Specifically, the touch display device 201 may further include a plurality of third conductive lines 232C, a plurality of sixth connecting pads P6 and a plurality of seventh connecting pads P7. The third conductive lines 232C, the sixth connecting pads P6 and the seventh connecting pads P7 are preferably formed from the patterned conductive layer 130, but not limited thereto. The first peripheral touch electrode 241 may include a first sub-electrode 241A and a second sub-electrode 241B. The first sub-electrode 241A and the second sub-electrode 241B may be a touch signal transmitting electrode and a touch signal receiving electrode respectively so as to perform the mutual capacitive touch sensing operation mode, but not limited thereto.

The first sub-electrode 241A and the second sub-electrode 241B may be electrically connected to the sixth connecting pad P6 and the seventh connected pad P7 respectively via the third conductive lines 232C. The sixth connecting pads P6 are disposed correspondingly to at least a part of the second connecting pads P2, and the seventh connecting pads P7 are disposed correspondingly to at least a part of the fourth connecting pads P4. Accordingly, the first sub-electrode 241A may be electrically connected to the touch signal lines 141A orderly via the third conductive line 232C, the sixth connecting pad P6, the first conductive adhesive material 150 and the second connecting pad P2. The second sub-electrode 241B maybe electrically connected to the touch signal lines 141A orderly via the third conductive line 232C, the seventh connecting pad P7, the first conductive adhesive material 150 and the fourth connecting pad P4. Additionally, the first sub-electrode 241A, the corresponding third conductive line 232C, and the corresponding sixth connecting pad P6 are preferably connected to one another and formed monolithically, and the second sub-electrode 241B, the corresponding third conductive line 232C, and the corresponding seventh connecting pad P7 are preferably connected to one another and formed monolithically, but not limited thereto.

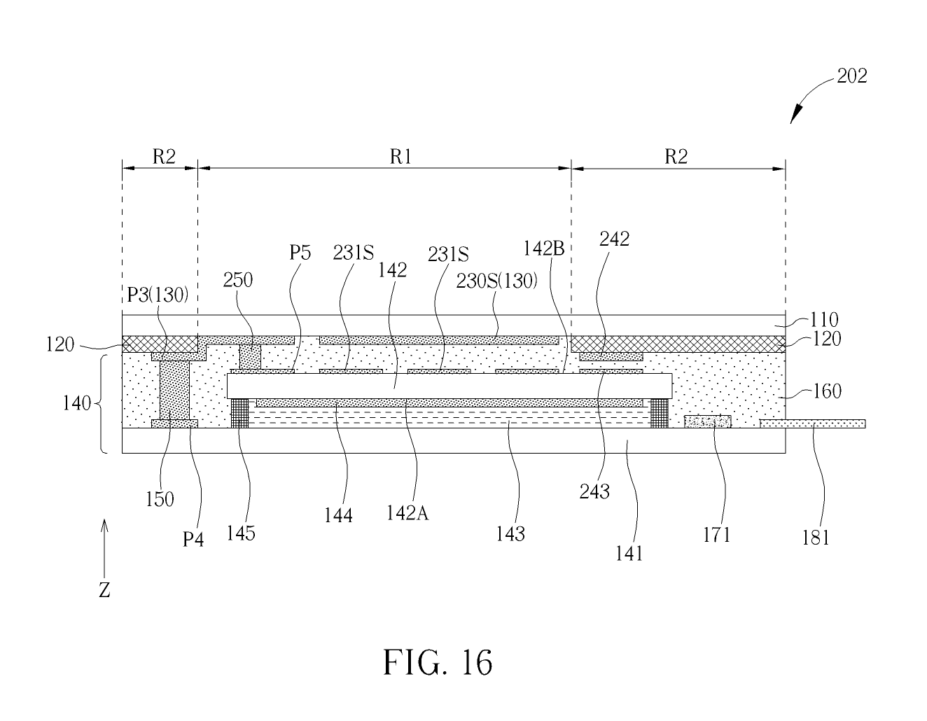

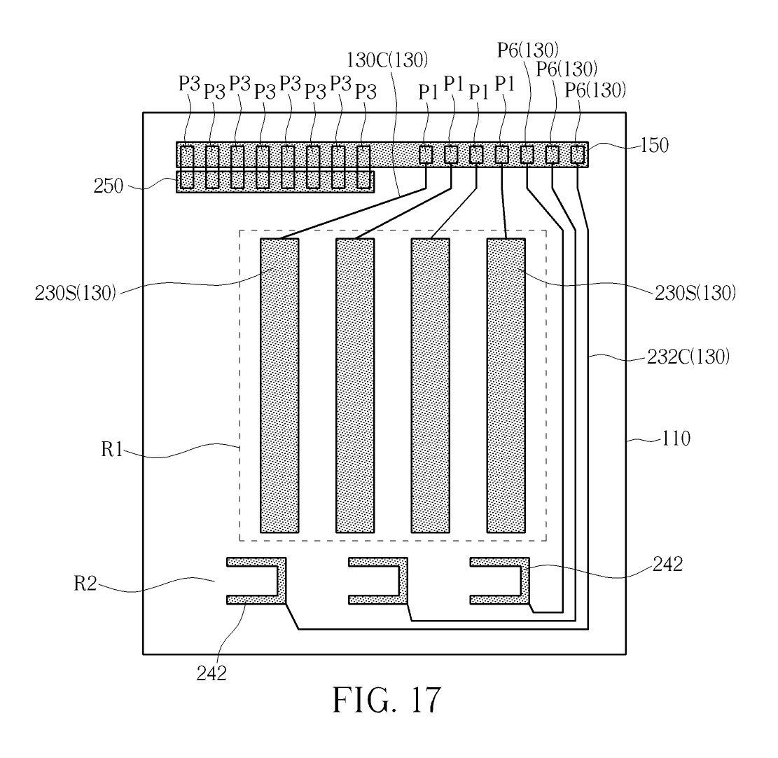

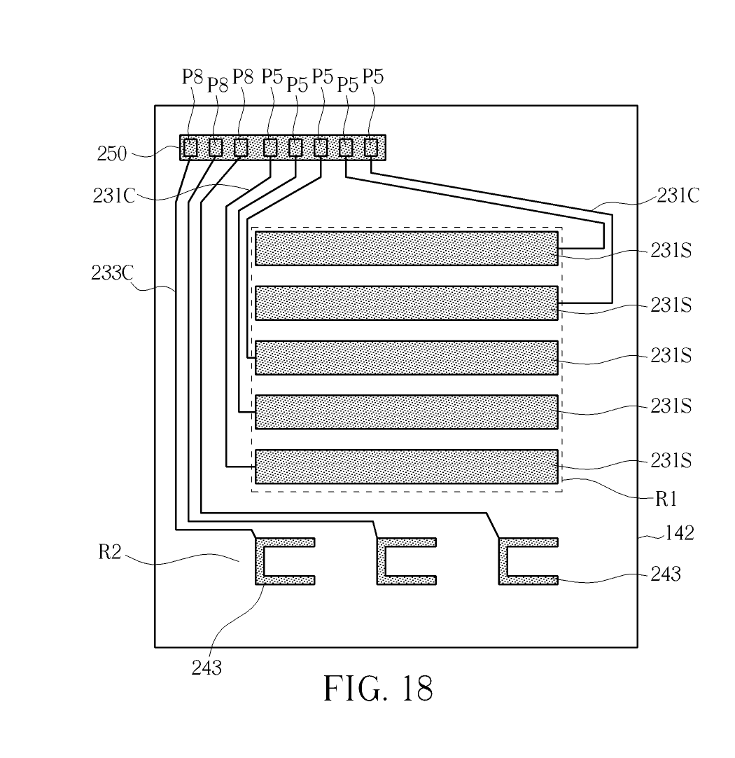

Please refer to FIGS. 15-18. FIG. 16 is a schematic diagram illustrating a touch display device according to a fourth preferred embodiment of the present invention. FIG. 17 is a top view diagram illustrating a cover substrate of the touch display device in this embodiment. FIG. 18 is a top view diagram illustrating an upper substrate of the touch display device in this embodiment. FIG. 15 may also be regarded as a top view diagram illustrating an array substrate of the touch display device in this embodiment. As shown in FIGS. 15-18, the difference between a touch display device 202 in this embodiment and the touch display device in the third preferred embodiment described above is that the touch display device 202 further includes at least one first peripheral touch electrode 242. The first peripheral touch electrode 242 is disposed on the cover substrate 110 and disposed in the peripheral region R2 so as to correspond to a button pattern (not shown) disposed on the cover substrate 110 in the peripheral region R2. In addition, the touch display device 202 further includes at least one second peripheral touch electrode 243 disposed on the outer surface 142B of the upper substrate 142, and the outer surface 142B faces the cover substrate 110. The second peripheral touch electrode 243 is disposed correspondingly to the first peripheral touch electrode 242. The first peripheral touch electrode 242 and the second peripheral touch electrode 243 maybe a touch signal transmitting electrode and a touch signal receiving electrode respectively so as to perform the mutual capacitive touch sensing operation mode, but not limited thereto.

The second peripheral touch electrode 243 is electrically connected to the array substrate 141 via the second conductive adhesive material 250, the third connecting pad P3 and the first conductive adhesive material 150. Specifically, the touch display device 202 may further include a plurality of eighth connecting pads P8 and a plurality of fourth conductive lines 233C disposed on the upper substrate 142. The eighth connecting pads P8 are disposed correspondingly to at least a part of the third connecting pads P3. Each of the eighth connecting pads P8 is electrically connected to one of the second peripheral touch electrode 243 via the fourth conductive line 233C. Accordingly, the second peripheral touch electrode 243 maybe electrically connected to the touch signal line 141A orderly via the fourth conductive line 233C, the eighth connecting pad P8, the second conductive adhesive material 250, the third connecting pad P3, the first conductive adhesive material 150 and the fourth connecting pad P4. In addition, the first peripheral touch electrode 242 is electrically connected to the touch signal line 141A orderly via the third conductive line 232C, the sixth connecting pad P6, the first conductive adhesive material 150 and the second connecting pad P2. The second peripheral touch electrode 243, the corresponding fourth conductive line 233C and the corresponding eighth connecting pad P8 are preferably connected to one another and formed monolithically, but not limited thereto.

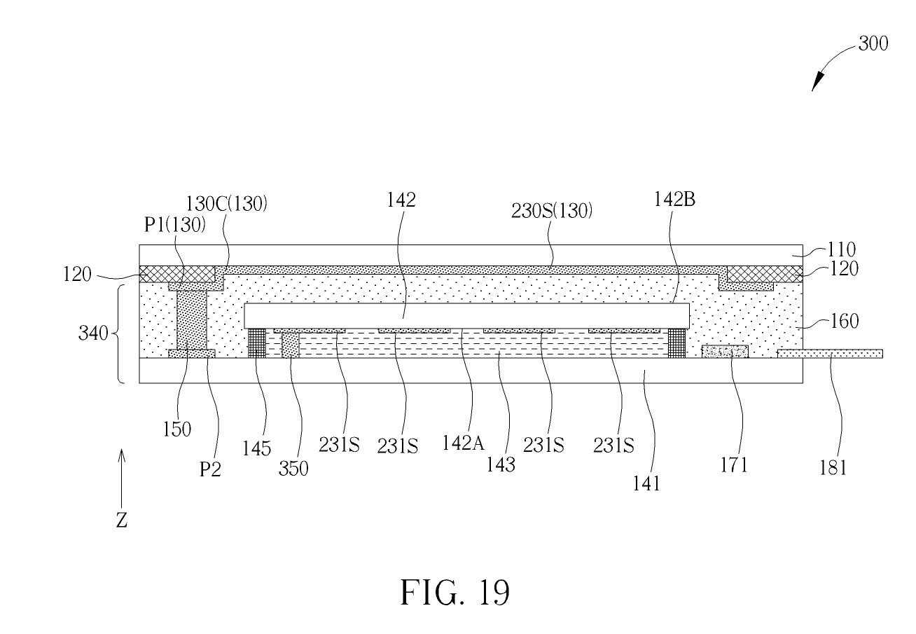

Please refer to FIG. 19. FIG. 19 is a schematic diagram illustrating a touch display device according to a fifth preferred embodiment of the present invention. As shown in FIG. 19, a touch display device 300 in this embodiment includes the cover substrate 110, a display panel 340, the decoration layer 120, the patterned conductive layer 130, the first conductive adhesive layer 150 and the second touch electrodes 231S. The difference between the touch display device 300 in this embodiment and the touch display device in the second preferred embodiment described above is that the second touch electrodes 231S in this embodiment are disposed on the inner surface 142A of the upper substrate 142, and the inner surface 142A is opposite to the cover substrate 110. The touch display device 300 further includes a third conductive adhesive material 350 disposed between the upper substrate 142 and the array substrate 141 so as to electrically connect the second touch electrodes 231S and the array substrate 141. The material properties and the electrical connecting mechanism of the third conductive adhesive material 350 are similar to those of the first conductive adhesive material 150 described above and will not be redundantly described. It is worth noting that the second touch electrodes 231S in this embodiment may also be used as common electrodes in the display panel 340. Time sequence of the touch signal and time sequence of the display signal may be separated from each other for sharing the second touch electrodes 231S, but not limited thereto.

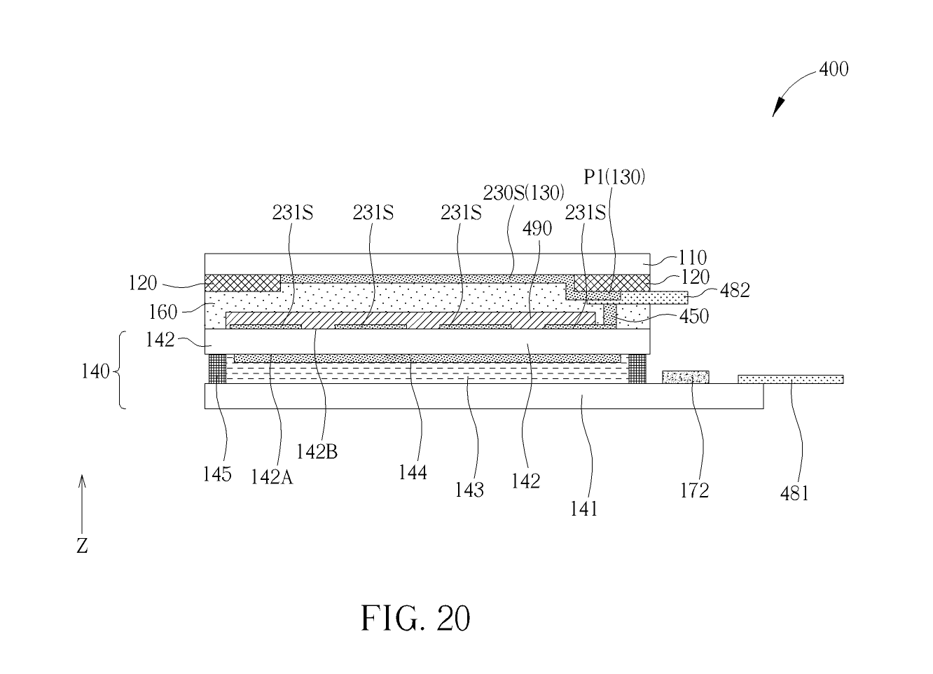

Please refer to FIG. 20. FIG. 20 is a schematic diagram illustrating a touch display device according to a sixth preferred embodiment of the present invention. As shown in FIG. 20, the difference between a touch display device 400 in this embodiment and the touch display device in the second preferred embodiment described above is that the touch display device 400 further includes a second conductive adhesive material 250, a flexible printed circuit 481 and a flexible printed circuit 482. The flexible printed circuit 481 is disposed on the array substrate 141 so as to transmit display signals to the display panel 140. The flexible printed circuit 482 is disposed on the cover substrate 110. The second conductive adhesive material 450 is disposed between the cover substrate 110 and the upper substrate 142 so as to electrically connect the second touch electrodes 231S and the flexible printed circuit 482. Additionally, the flexible printed circuit 482 is electrically connected to the first touch electrode 230S via the first connecting pad P1, and the flexible printed circuit 482 may also be used to transmit touch signals to the first touch electrode 230S and the second touch electrode 231S. In addition, the touch display device 400 may further include a protection layer 490 covering the second touch electrodes 231S so as to protect the second touch electrodes 231S. It is worth noting that the protection layer may also be disposed on each touch electrode in the embodiments of the present invention so as to protect the touch electrodes, but not limited thereto. In this embodiment, the first touch electrodes 230S are signal receiving electrodes, and the second touch electrodes 231S are signal transmitting electrodes preferably. The second conductive adhesive material 450 is disposed between the cover substrate 110 and the upper substrate 142 so as to electrically connect the second touch electrodes 231S and the cover substrate 110 or to electrically connect the first touch electrodes 230S and the upper substrate 142. Alternatively, the flexible printed circuit 482 may be disposed on the upper substrate 142 so as to be electrically connected to the second touch electrodes 231S. The second conductive adhesive material 450 is disposed between the cover substrate 110 and the upper substrate 142 so as to electrically connect the first touch electrodes 230S and the flexible printed circuit 482 disposed on the upper substrate 142. Moreover, the flexible printed circuit 482 and the flexible printed circuit 481 can be integrated into a one-piece flexible printed circuit and thus the one-piece flexible printed circuit can transmit display signals to the display panel.

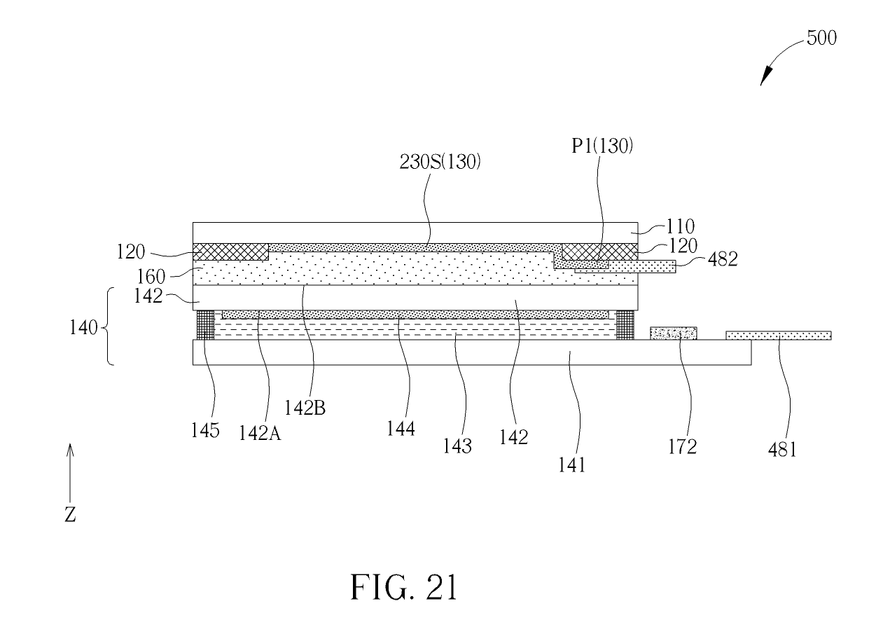

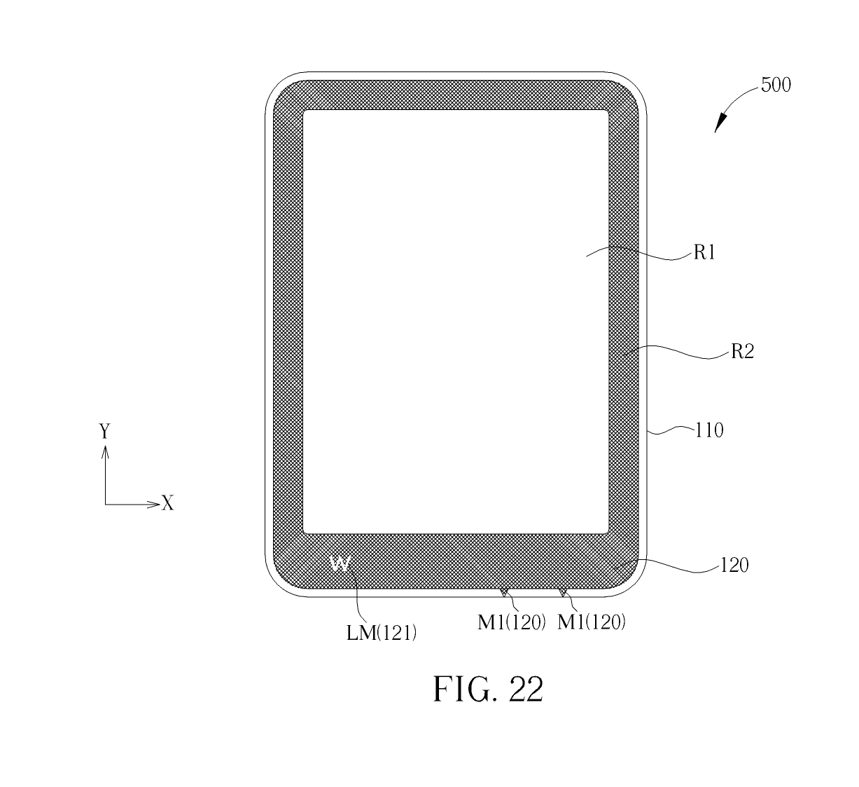

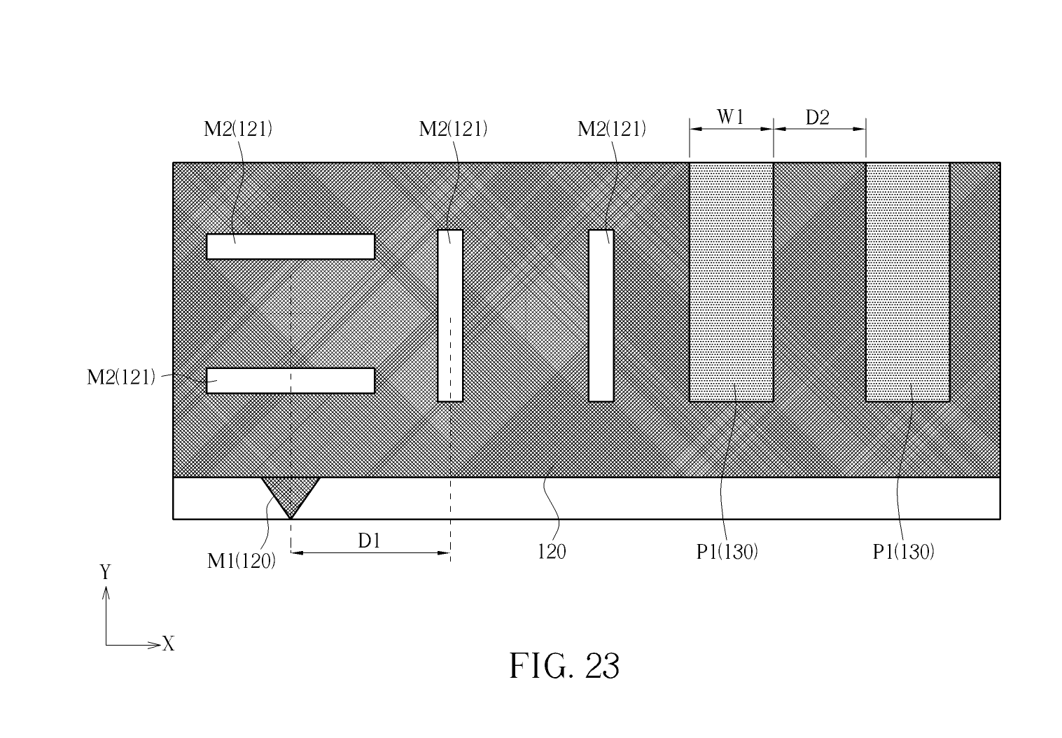

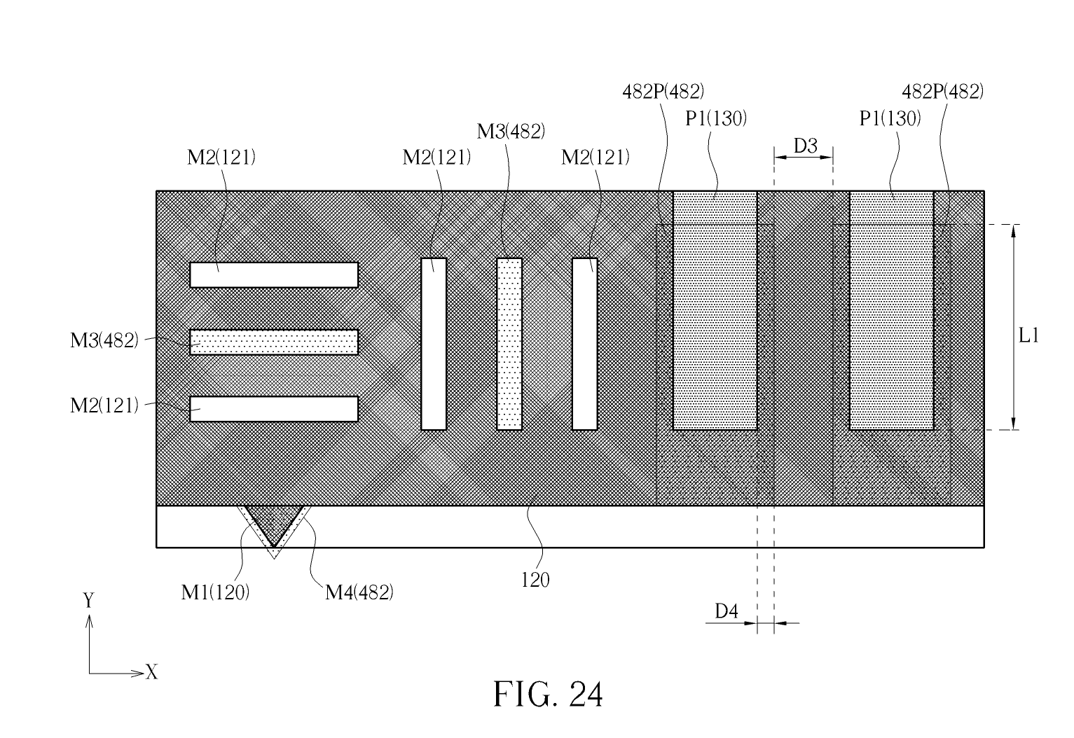

Please refer to FIGS. 21-24. FIG. 21 is a schematic diagram illustrating a touch display device according to a seventh preferred embodiment of the present invention. FIG. 22 is a top view diagram illustrating the touch display device in this embodiment. FIG. 23 is a partially enlarged diagram of FIG. 22. FIG. 24 is an enlarged schematic diagram illustrating a connecting region between the touch display device and a flexible printed circuit in this embodiment. As shown in FIGS. 21-24, the difference between a touch display device 500 in this embodiment and the touch display device in the first preferred embodiment described above is that the touch display device 500 further includes the flexible printed circuit 482 disposed on the cover substrate 110 so as to electrically connect the first connecting pads P1 and the first touch electrodes 230S. In other words, the flexible printed circuit 482 may be combined with the cover substrate 110 by a bonding process, but not limited thereto. Additionally, in the touch display device 500 of this embodiment, the decoration layer 120 may preferably include a plurality of first alignment mark M1 disposed on an edge of the cover substrate 110 so as to assist the aligning condition during the bonding process between the flexible printed circuit 482 and the cover substrate 110. The first alignment mark M1 is preferably a triangle pattern, but not limited thereto. It is worth noting that the touch display device 500 may further include a background layer 121 disposed on the cover substrate 110 within the peripheral region R2. The background layer 121 is preferably disposed on the decoration layer 120, but not limited thereto. The background layer 121 may be used to form a pattern LM in the peripheral region R2 and a plurality of second alignment marks M2 in a region where the flexible printed circuit 482 is designed to be bonded to. The background layer 121 is preferably a decoration material, such as mirror silver, formed on the cover substrate 110 by a printing process, but not limited thereto. In other words, the background layer 121 may include a plurality of the second alignment marks M2 disposed on the decoration layer 120, but not limited thereto.

When the flexible printed circuit 482 is bonded to the cover substrate 110 (as shown in FIG. 24), a third alignment mark M3 on the flexible printed circuit 482 and the second alignment marks M2 may be mainly used to complete aligning steps, or/and a fourth alignment mark M4 on the flexible printed circuit 482 and the first alignment mark M1 may be used to complete the aligning steps. Connecting parts 482P on the flexible printed circuit 482 may effectively contact corresponding first connecting pads P1 so as to be electrically connected to the corresponding first connecting pads P1 accordingly. Under the structure described above, the yield of the bonding process for flexible printed circuit 482 may still be ensured even though there is no metal alignment marks disposed on the cover substrate of the present invention. It is worth noting that, as shown in FIG. 23, a distance D1 between the first alignment mark M1 and the second alignment mark M2 may also be used to monitor the printing condition of the background layer 121. The deviation value between the distance D1 and a designed value may be used to compensate the alignment condition in the subsequent bonding process of the flexible printed circuit. As shown in FIG. 23 and FIG. 24, a distance D2 is defined as a distance between two adjacent first connecting pads P1, a distance D3 is defined as a distance between two adjacent connecting parts 482P, a distance D4 is defined as a distance between the connecting part 482P and the corresponding first connecting pad P1, and each of the first connecting pads P1 has a width W1. Printing accuracy of the printing process for forming the background layer 121 is preferably smaller than the distance D2, and the printing accuracy is preferably larger than a sum of the width W1 and two times of the distance D4. Additionally, the distance D4 is preferably a half of a difference between the distance D2 and the distance D3, and the width W1 is preferably larger than the distance D4. An overlapping length L1 between each connecting part 482P and the corresponding first connecting pad P1 is preferably larger than the printing accuracy mentioned above. Based on the above-mentioned size relation between the alignment marks, the connecting pads P1 and the connecting parts 482P, the condition of the bonding process between the flexible printed circuit and the cover substrate may be further ensured, and the relative yield may be enhanced accordingly.

To summarize the above descriptions, in the touch display device of the present invention, the conductive adhesive material is used to electrically connect the touch electrodes and the array substrate. The touch driving unit may be electrically connected to the touch electrodes via the array substrate, the touch driving unit may not have to be disposed on the cover substrate where the touch electrodes are disposed on, and metal alignment marks are not required to be formed on the cover substrate accordingly. Therefore, the purposes of yield enhancement and process simplification may be achieved. Additionally, the conductive adhesive material may be used to establish electrical connections by a full conduction approach. The adhesive combination and electrical connection may be completed without performing precise alignment steps. The purpose of process simplification may be accordingly achieved. The effect of the present invention is more obvious especially when the amount of the connecting pads increases, the connecting pads are disposed closely to one another, and/or the connecting pads are transparent.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display device, comprising:
a cover substrate, wherein a visible region and a peripheral region adjacent to at least one side of the visible region are defined on the cover substrate;
a display panel, disposed opposite to the cover substrate, the display panel comprising:
an upper substrate and an array substrate disposed opposite to the upper substrate, wherein the upper substrate is disposed between the cover substrate and the array substrate; and
a display medium, disposed between the upper substrate and the array substrate;
a plurality of first touch electrodes, at least disposed in the visible region of the cover substrate;
a plurality of first connecting pads, disposed in the peripheral region, wherein each of the first connecting pads is electrically connected to one of the first touch electrodes; and
a first conductive adhesive material, disposed between the cover substrate and the array substrate so as to electrically connect the first connecting pads and the array substrate.

2. The touch display device of claim 1, wherein the first conductive adhesive material comprises an adhesive material and a plurality of conductive particles.

3. The touch display device of claim 1, further comprising a plurality of first conductive lines, wherein each of the first conductive lines is connected to one of the first touch electrodes and one of the first connecting pads.

4. The touch display device of claim 3, wherein the first touch electrodes, the first connecting pads, and the first conductive lines are one patterned conductive layer.

5. The touch display device of claim 4, wherein the patterned conductive layer is a transparent conductive material.

6. The touch display device of claim 1, wherein the array substrate comprises a plurality of second connecting pads disposed correspondingly to the first connecting pads.

7. The touch display device of claim 6, wherein the first conductive adhesive material contacts the first connecting pads and the second connecting pads by a full conduction approach so as to electrically connect each first connecting pad and one of the second connecting pads corresponding to the first connecting pad, to electrically isolate the first connecting pads from one another, and to electrically isolate the second connecting pads from one another.

8. The touch display device of claim 7, wherein the array substrate further comprises a plurality of touch signal lines, each of the touch signal lines is connected to one of the second connecting pads.

9. The touch display device of claim 8, further comprising a touch driving unit electrically connected to the touch signal lines.

10. The touch display device of claim 9, wherein the touch driving unit is disposed on the array substrate.

11. The touch display device of claim 9, further comprising a flexible printed circuit electrically connected to the array substrate, wherein the touch driving unit is disposed on the flexible printed circuit.

12. The touch display device of claim 1, wherein the first touch electrodes comprises a plurality of signal transmitting electrodes and a plurality of signal receiving electrodes.

13. The touch display device of claim 1, further comprising a plurality of second touch electrodes, disposed on an outer surface of the upper substrate, wherein the outer surface of the upper substrate faces the cover substrate.

14. The touch display device of claim 13, further comprising a second conductive adhesive material and a plurality of third connecting pads, wherein the second conductive adhesive material is disposed between the cover substrate and the upper substrate, the third connecting pads are disposed on the cover substrate, and the second conductive adhesive material electrically connects the second touch electrodes and the third connecting pads.

15. The touch display device of claim 14, wherein the array substrate comprises a plurality of fourth connecting pads disposed correspondingly to the third connecting pads, and each of the fourth connecting pads is electrically connected to one of the third electrodes via the first conductive adhesive material.

16. The touch display device of claim 1, further comprising a plurality of second touch electrodes, disposed on an inner surface of the upper substrate, wherein the inner surface of the upper substrate is opposite to the cover substrate.

17. The touch display device of claim 16, further comprising a third conductive adhesive material, disposed between the upper substrate and the array substrate so as to electrically connect the second touch electrodes and the array substrate.

18. The touch display device of claim 1, further comprising at least one first peripheral touch electrode, disposed in the peripheral region, wherein the first peripheral touch electrode is electrically connected to the array substrate via the first conductive adhesive material.

19. The touch display device of claim 18, further comprising at least one second peripheral touch electrode, disposed on an outer surface of the upper substrate, wherein the outer surface of the upper substrate faces the cover substrate, and the second peripheral touch electrode is disposed correspondingly to the first peripheral touch electrode.

20. The touch display device of claim 1, wherein the first connecting pads are transparent conductive material.

21. The touch display device of claim 1, wherein a pitch between two adjacent first connecting pads is smaller than or equal to 0.25 millimeter.

22. The touch display device of claim 1, further comprising a decoration layer, disposed on the peripheral region of the cover substrate.

23. A touch display device, comprising:
a cover substrate, wherein a visible region and a peripheral region adjacent to at least one side of the visible region are defined on the cover substrate;
a display panel, disposed opposite to the cover substrate, the display panel comprising:
an upper substrate and an array substrate disposed opposite to the upper substrate, wherein the upper substrate is disposed between the cover substrate and the array substrate; and
a display medium, disposed between the upper substrate and the array substrate;
a plurality of first touch electrodes, at least disposed in the visible region of the cover substrate;
a plurality of second touch electrodes, disposed on the upper substrate of the display panel; and
a conductive adhesive material, disposed between the cover substrate and the upper substrate so as to electrically connect the second touch electrodes and the cover substrate.

24. The touch display device of claim 23, wherein the first touch electrodes are signal receiving electrodes, and the second touch electrodes are signal transmitting electrodes.

25. The touch display device of claim 23, further comprising a flexible printed circuit electrically connected to the cover substrate.

26. A touch display device, comprising:
a cover substrate, wherein a visible region and a peripheral region adjacent to at least one side of the visible region are defined on the cover substrate;
a display panel, disposed opposite to the cover substrate, the display panel comprising:
an upper substrate and an array substrate disposed opposite to the upper substrate, wherein the upper substrate is disposed between the cover substrate and the array substrate; and
a display medium, disposed between the upper substrate and the array substrate;
a plurality of first touch electrodes, at least disposed in the visible region of the cover substrate;
a plurality of second touch electrodes, disposed on the upper substrate of the display panel; and
a conductive adhesive material, disposed between the cover substrate and the upper substrate so as to electrically connect the first touch electrodes and the upper substrate.

27. The touch display device of claim 26, wherein the first touch electrodes are signal receiving electrodes, and the second touch electrodes are signal transmitting electrodes.

28. The touch display device of claim 26, further comprising a flexible printed circuit electrically connected to the upper substrate.

29. The touch display device of claim 28, wherein the flexible printed circuit transmits display signals to the display panel.
